(19) United States
(12) Patent Application Publication
(10) Pub. No.: US 2025/0320955 A1
(43) Pub. Date: Oct. 16, 2025

(54) TRIPOD HEAD

(71) Applicant: TILTA INC., Burbank, CA (US)

(72) Inventors: Weihan SHE, Shenzhen (CN); Wenping ZENG, Shenzhen (CN); Kefeng ZHOU, Shenzhen (CN)

(21) Appl. No.: 19/171,055

(22) Filed: Apr. 4, 2025

(30) Foreign Application Priority Data
Apr. 11, 2024 (CN) 2024207478776

(51) Int. Cl. F16M 11/12; F16M 11/34

(52) U.S. Cl. CPC F16M 11/126; F16M 11/34; F16M 2200/024

(57) ABSTRACT

The tripod head includes a case, a pivot shaft, and a mounting assembly. The mounting assembly is movably arranged on the case, and the pivot shaft is movably arranged inside the case and connected to the mounting assembly. Multiple energy storage components are sleeved onto the pivot shaft. The tripod head also includes multiple groups of locking assemblies, wherein the multiple energy storage components are divided into multiple groups, and the multiple groups of locking assemblies correspond respectively to the multiple groups of energy storage components. The case is also movably equipped with a first actuating member and a second actuating member, wherein the first actuating member is connected to one group of the locking assemblies, and the second actuating member is connected to another group of the locking assemblies.

### CROSS-REFERENCE TO RELATED APPLICATIONS

The present application for patent claims priority to and the benefit of pending Chinese Application No. 2024207478776, filed Apr. 11, 2024, and hereby expressly incorporated by reference herein as if fully set forth below in its entirety and for all applicable purposes.

### TECHNICAL FIELD

The present disclosure pertains to the field of photographic equipment, specifically to a tripod head.

### INTRODUCTION

During photography, auxiliary equipment is often utilized to assist in achieving desired photographic effects. A tripod head, for instance, is a common piece of photographic auxiliary equipment.

When in use, a tripod head allows for the mounting of photographic equipment. Typically, a balancing structure is provided within the tripod head to counterbalance varying loads on the photographic equipment. Additionally, the tripod head is equipped with adjustment buttons that can be used to adjust the load settings, thereby enabling the adjustment of the weight that the balancing structure can support. However, existing tripod heads lack sufficiently diverse load adjustment settings, making it challenging to accommodate a variety of photographic equipment with different weights.

### BRIEF SUMMARY

The present disclosures provide a tripod head with more diverse load adjustment settings, capable of accommodating various photographic equipment with different weights.

The technical solution of the present disclosure is as follows:

A tripod head, including a case, a mounting assembly for installing photographic equipment, wherein the mounting assembly is movably arranged on the case, and a pivot shaft movably arranged inside the case and connected to the mounting assembly, with multiple energy storage components sleeved onto the pivot shaft;
the tripod head also comprises multiple groups of locking assemblies for controlling the energy storage components, wherein the multiple energy storage components are divided into multiple groups, and the multiple groups of locking assemblies correspond respectively to the multiple groups of energy storage components; the case is also movably equipped with a first actuating member and a second actuating member for controlling the corresponding locking assemblies, wherein the first actuating member is connected to one group of the locking assemblies, and the second actuating member is connected to another group of the locking assemblies.

### BRIEF DESCRIPTION OF THE DRAWINGS

FIG. 1 is a diagram illustrating a tripod according to some aspects of the disclosure.

FIG. 2 is a diagram illustrating a tripod head without the tripod legs according to some aspects of the disclosure.

FIG. 3 is a diagram illustrating an exploded view of the tripod head without a mounting assembly, and a part of the case according to some aspects of the disclosure.

FIG. 4 is a diagram illustrating a pivot shaft, a plurality of energy storage components, a plurality of locking assemblies, a first trigger pins, and a second trigger pin.

FIG. 5 is a diagram illustrating a first actuating member according to some aspects of the disclosure.

FIG. 6 is a diagram illustrating a second actuating member diagram illustrating.

FIG. 7 is a diagram illustrating a first-perspective exploded view of the pivot shaft, damping actuating member, damping plate assembly, and part of the case.

FIG. 8 is a diagram illustrating a second-perspective exploded view of the pivot shaft, damping actuating member, damping plate assembly, and part of the case.

### REFERENCE NUMBERS

1. case; 11. first actuating zone; 111. first trigger hole; 112. first trigger pin; 12. second actuating zone; 121. second trigger hole; 122. second trigger pin; 123. sliding groove; 124. guiding element; 125. guide hole; 13. adjusting post; 131. locking protrusion; 14. rotating groove; 15. tripod;
2. pivot shaft;
3. mounting assembly; 31. side plate; 32. quick-release plate;
4. energy storage component; 41. inner ring; 42. outer ring; 43. locking groove;
5. locking assembly; locking member; 52. locking spring; 53. locking shaft;
6. first actuating member; 61. first locking trigger; 611. recess area; 612. protrusion area; 62. bead groove; 63. actuating bead;
7. second actuating member; 71. second locking trigger; 72. connecting part
9. damping plate assembly.

### DETAILED DESCRIPTION

To clarify the objectives, technical solutions, and aspects of the present disclosure, the following provides a detailed description with reference to the drawings and examples. The specific examples described herein are exemplary and do not limit the scope of the present disclosure.

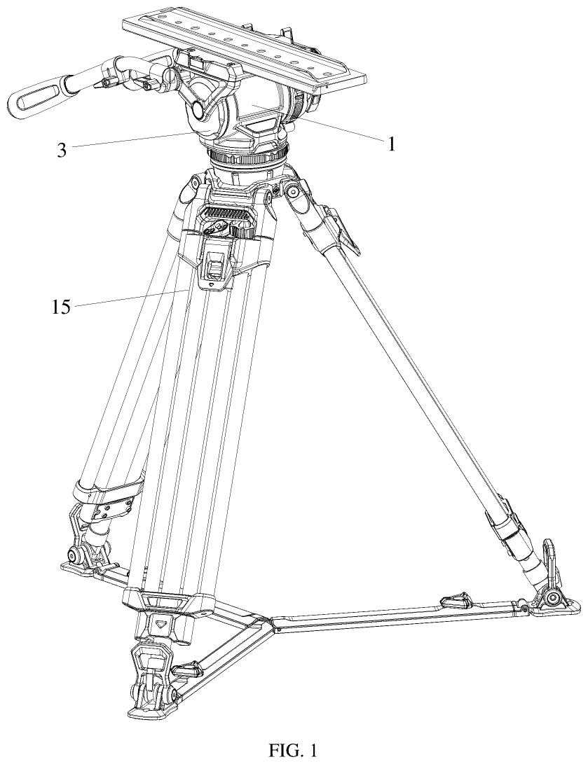

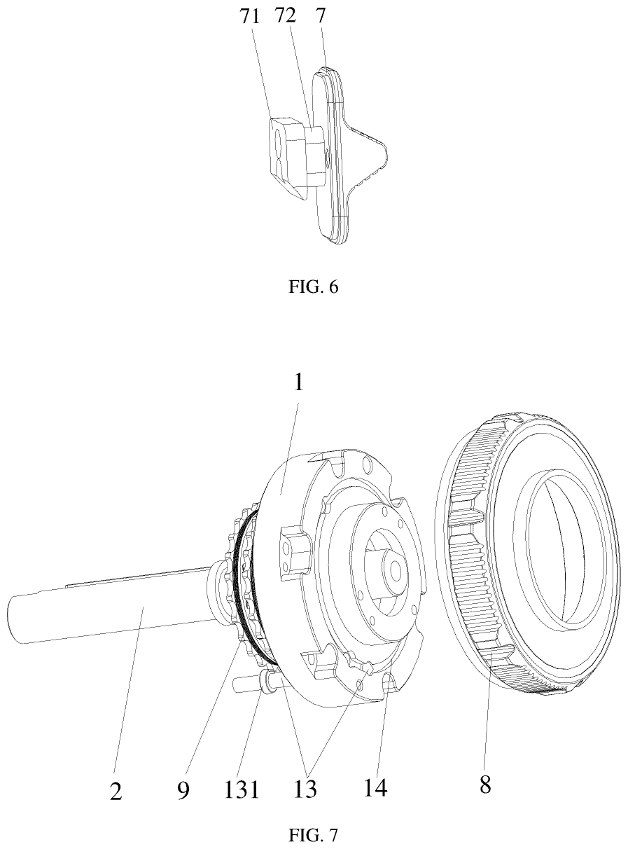

With reference to FIGS. 1-8, a tripod head includes a case 1, a pivot shaft 2, and a mounting assembly 3 configured to install photography equipment. The mounting assembly 3 is movably arranged on the case 1. The pivot shaft 2 is movably positioned inside the case 1 and is connected to the mounting assembly 3. Multiple energy storage components 4 are sleeved on the pivot shaft 2.

The tripod head further includes multiple groups of locking assemblies 5 for controlling the energy storage components 4. The multiple energy storage components 4 are divided into several groups, and the multiple groups of locking assemblies 5 correspond to these groups of energy storage components 4 respectively. The case 1 is also equipped with a first actuating member 6 and a second actuating member 7 that are movably arranged to control the corresponding locking assemblies 5. The first actuating member 6 is connected to one group of locking assemblies 5, while the second actuating member 7 is connected to another group of locking assemblies 5. Each group of locking assemblies 5 is configured to include one locking assembly or more locking assemblies.

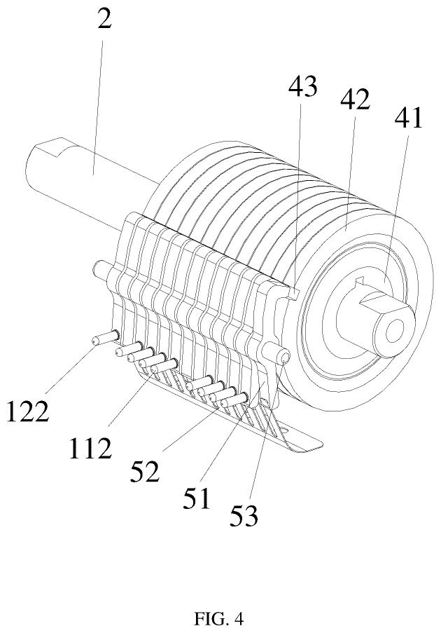

With reference to FIG. 4, specifically, each energy storage component 4 includes an inner ring 41 and an outer ring 42. The inner ring 41 is fixedly sleeved on the pivot shaft 2, and the outer ring 42 is sleeved outside the inner ring 41, corresponding to the locking assembly 5. When the energy storage component 4 is locked, the outer ring 42 and the inner ring 41 can rotate relative to each other. At this point, a certain resilient force (or resistance) needs to be overcome when the inner ring 41 and the outer ring 42 rotate, and the energy storage component 4 functions as a counterweight.

In some aspects, the counterweight of the energy storage component 4 controlled by the locking assembly 5 corresponding to the second actuating member 7 can be 0.5 kg, and the counterweight of the energy storage component 4 controlled by the locking assembly 5 corresponding to the first actuating member 6 can be either 2 kg or 1 kg. Through the combined counterweight adjustments of the first actuating member 6 and the second actuating member 7, the tripod head can achieve more gear adjustment combinations to accommodate various photography equipment with different weights. It is important to note that the weight values mentioned herein do not restrict the energy storage component 4 to only these values. The load weights of the energy storage components 4 can be customized according to specific requirements. For example, the counterweight of the energy storage component 4 controlled by the locking assembly 5 corresponding to the second actuating member 7 can be 0.1 kg, 0.2 kg, 0.3 kg, 0.4 kg, etc., and the counterweight of the energy storage component 4 controlled by the locking assembly 5 corresponding to the first actuating member 6 can also be 3 kg, 4 kg, 5 kg, etc.

In some aspects, reference to FIG. 4, a locking shaft 53 is arranged inside the case 1. The locking assembly 5 includes a locking member 51 and a locking spring 52. The middle part of the locking member 51 is movably sleeved on the locking shaft 53. A locking groove 43 is arranged on the side of the energy storage component 4, with one end of the locking member 51 corresponding to the locking groove 43. The locking spring 52 is fixedly arranged inside the case 1 and abuts against the other side of the locking member 51. Furthermore, the first actuating member 6 controls the other end of the corresponding locking member 51 to compress (in a first position) or release (in a second position) the locking spring 52, and the second actuating member 7 controls the other end of the corresponding locking member 51 to compress (in a first position) or release (in a second position) the locking spring 52.

In some aspects, the locking springs 52 of multiple locking assemblies 5 are connected together to form a plate spring structure including multiple locking springs 52.

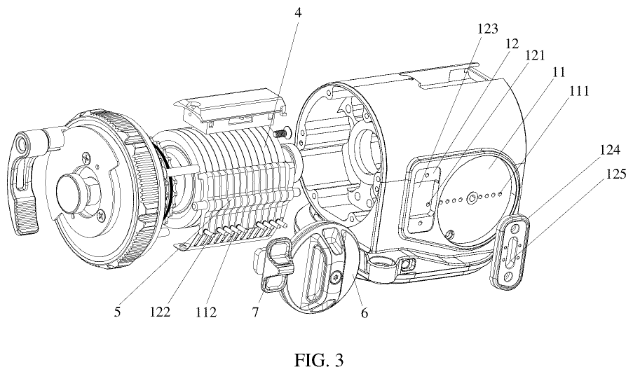

With reference to FIGS. 3-5, in some aspects, a first actuating zone 11 is arranged on the case 1 (see FIG. 3). The first actuating zone 11 includes one or more first trigger holes 111, and a first trigger pin 112 is movably arranged inside each first trigger hole 111. The first actuating member 6 is provided with one or more first locking trigger parts 61 for controlling the compression of the first trigger pins 112. The first actuating member 6 is movably arranged inside the first actuating zone 11, and multiple first locking trigger parts 61 correspond to multiple first trigger pins 112 respectively. The first trigger pins 112 abut against the other side of the corresponding locking members 51 opposite to the locking springs 52.

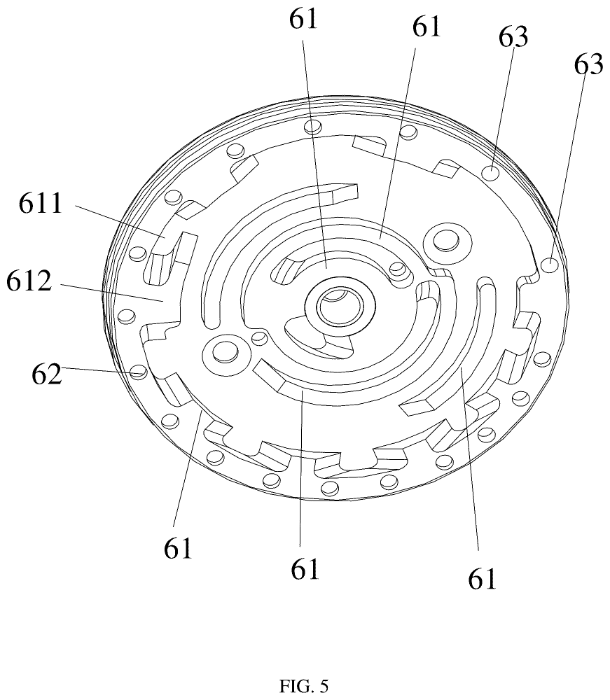

In some aspects, reference to FIG. 5, the first actuating member 6 is rotatably and movably arranged inside the first actuating zone 11, and multiple actuating beads 63 are annularly arranged between the first actuating member 6 and the first actuating zone 11. Specifically, multiple bead grooves 62 are annularly arranged on the first actuating member 6, and the actuating beads 63 are arranged inside the bead grooves 62.

In some aspects, multiple first locking trigger parts 61 are annularly arranged on (or sequentially arranged around) the first actuating member 6 in sequence along the diameter of the first actuating member 6.

In some aspects, the first actuating zone 11 includes eight first trigger holes 111 arranged in a row, with four first trigger holes 111 on each side of the rotation center of the first actuating member 6. There are four first locking trigger parts 61, which are annularly arranged on the first actuating member 6 in sequence along the diameter of the first actuating member 6. Each first locking trigger part corresponds to the first trigger pins 112 in two symmetrical first trigger holes 111. The first locking trigger part 61 includes a recess area 611 and a protrusion area 612. When the first actuating member 6 is rotated such that the first trigger pins 112 align with the recess areas 611 of the corresponding first locking trigger parts 61, at this point, the locking spring 52 abuts against the other end of the locking member 51, and the locking member 51 rotates about the locking shaft 53, with one end extending into the locking groove 43 to lock the energy storage component 4. When the first actuating member 6 is rotated such that the first trigger pins 112 align with the protrusion areas 612 of the corresponding first locking trigger parts 61, the first locking trigger part 61 can press down the first trigger pins 112 through the protrusion areas 612, so that the first trigger pins 112 press down the other end of the corresponding locking members 51 to compress the locking springs 52, and one end of the locking members 51 detaches from the locking grooves 43.

In some aspects, the counterweight of the energy storage component 4 corresponding to one first trigger pin 112 at the side of the first actuating zone 11 is 1 kg (e.g., as illustrated in FIG. 4, the energy storage component 4 corresponding to the leftmost first trigger pin 112), and the counterweight of the energy storage components 4 corresponding to the other first trigger pins 112 is half of 2 kg. Among the multiple gears adjusted when the first actuating member 6 rotates, when the first actuating member 6 rotates to the first gear, the first trigger pin 112 corresponding to the energy storage component 4 with a counterweight of 1 kg aligns with the recess area 611 of the first actuating member 6, and the other first trigger pins 112 in the first actuating zone 11 all align with the protrusion areas 612. At this point, the energy storage component 4 with a counterweight of 1 kg is locked, generating a counterweight of 1 kg.

In some aspects, the plurality of locking assemblies 5 are configured in three parts, there are three parts of locking assemblies 5, and one part of the locking assemblies 5 includes a fixedly locked energy storage component 4. The locking members 51 in this part of locking assemblies 5 for fixedly locking the energy storage component 4 can be distributed at the rotation center of the first actuating zone 11 and at the left and right sides of the first actuating zone 11, etc. No trigger pins are arranged at these positions. Therefore, under the action of the locking springs 52, the locking members 51 in this group of locking assemblies 5 are always in a state of hooking (or engaging) the locking grooves 43 of the energy storage components 4, so that the tripod head has a fixed counterweight. Consequently, when the first actuating member 6 rotates to the first gear, the initial counterweight of the tripod head is 1 kg plus the fixed counterweight. When the fixed counterweight is 2 kg, the initial counterweight is 3 kg; when the fixed counterweight is 4 kg, the initial counterweight is 5 kg. Each part locking assembly 5 is capable of including one locking assembly 5 or more locking assemblies 5.

In some aspects, when the first actuating member 6 shifts gears, the counterweight increases by 1 kg per gear.

For example, for the second gear, the first actuating member 6 rotates counterclockwise once. The first trigger pin 112 corresponding to the energy storage component 4 with a counterweight of 1 kg aligns with the protrusion area 612 of the first actuating member 6, and one of the other first trigger pins 112 in the first actuating zone 11 moves to align with the recess area 611. At this point, the energy storage component 4 with a counterweight of 2 kg is locked, resulting in a counterweight of 2 kg.

For the third gear, the first actuating member 6 rotates counterclockwise once. The first trigger pin 112 corresponding to the energy storage component 4 with a counterweight of 1 kg aligns with the recess area 611 of the first actuating member 6, and the energy storage component 4 with a counterweight of 1 kg is locked. Additionally, one of the other first trigger pins 112 in the first actuating zone 11 continues to align with the recess area 611, and at this point, the energy storage component 4 with a counterweight of 2 kg is locked, resulting in a counterweight of 3 kg.

For the fourth gear, the first actuating member 6 rotates counterclockwise once. The first trigger pin 112 corresponding to the energy storage component 4 with a counterweight of 1 kg aligns with the protrusion area 612 of the first actuating member 6, and two of the other first trigger pins 112 in the first actuating zone 11 move to align with the recess areas 611. At this point, the energy storage component 4 with a counterweight of 4 kg is locked, resulting in a counterweight of 4 kg.

According to the above description, when an odd gear needs to be added, the first trigger pin 112 corresponding to the energy storage component 4 with a counterweight of 1 kg at the outermost side falls into the recess area 611.

When an even gear needs to be added, the first trigger pin 112 corresponding to the energy storage component 4 with a counterweight of 1 kg at the outermost side falls into the protrusion area 612, and simultaneously, the first trigger pin 112 corresponding to the newly added energy storage component 4 with a counterweight of 2 kg falls into the recess area 611.

With reference to FIGS. 3-6, in some aspects, a second actuating zone 12 is arranged on the case 1. The second actuating zone 12 includes one or more second trigger holes 121, and a second trigger pin 122 is movably arranged within each second trigger hole 121. The second actuating member 7 is provided with more than one second locking trigger parts 71 for controlling the compression of the second trigger pins 122. The second actuating member 7 is movably arranged within the second actuating zone 12, with the second locking trigger parts 71 corresponding to the second trigger pins 122, and the second trigger pins 122 abutting against the other side of the corresponding locking members 51 opposite to the locking springs 52.

Specifically, when the second locking trigger part 71 abuts against the second trigger pin 122, the second trigger pin 122 abuts against the corresponding locking member 51. After compressing the locking spring 52 and rotating, the second trigger pin 122 detaches from the locking groove 43. When the second locking trigger part 71 detaches from the second trigger pin 122, the compressed locking spring 52 returns to its original position, controlling the locking member 51 to rotate about the locking shaft 53, with one end extending into the locking groove 43 to lock the energy storage component 4, resulting in a counterweight of 0.5 kg.

In some aspects, a sliding groove 123 is vertically arranged within the second actuating zone 12, the second trigger holes 121 are arranged within the sliding groove 123, and the second locking trigger parts 71 are vertically movably arranged within the sliding groove 123.

In some aspects, a guiding element 124 is arranged on the second actuating zone 12. The guiding element 124 is provided with a guide hole 125, and the guide hole 125 is connected to the sliding groove 123. A connecting part 72 is fixed on the second actuating member 7, and the second actuating member 7 is movably arranged on the guiding element 124. The connecting part 72 passes through the guide hole 125 to be fixed to the second locking trigger part 71 within the sliding groove 123. The second actuating member 7 moves in a sliding manner and is guided by the cooperation of the connecting part 72 and the guiding element 124, ensuring smoother sliding.

In some aspects, the above-mentioned pivot shaft 2, energy storage components 4, locking assemblies 5, first actuating member 6, and second actuating member 7, etc., constitute a counterweight adjustment structure for the pitch angle of the tripod head. They can also be applied to the counterweight adjustment structure for the yaw angle of the tripod head.

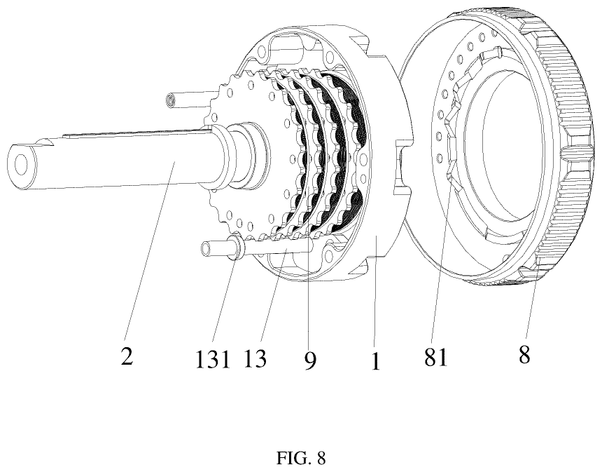

With reference to FIGS. 7-8, in this embodiment, the tripod head is further provided with a damping actuating member 8. The damping actuating member 8 is rotatably arranged on the case 1. Multiple damping plate assemblies 9 are sleeved on the pivot shaft 2. The case 1 is also movably provided with an adjusting post 13. The adjusting post 13 is provided with locking protrusions 131 for clamping the damping plate assemblies 9. The locking protrusions 131 correspond to multiple damping plate assemblies 9, and the damping actuating member 8 is provided with damping triggers 81 for driving the locking protrusions 131 to move. The damping triggers 81 are connected to the adjusting post 13.

In some aspects, there are multiple adjusting posts 13, and there are multiple damping triggers 81 on the damping actuating member 8. The multiple damping triggers 81 correspond to the multiple adjusting posts 13.

In some aspects, a rotating groove 14 is arranged on the side of the case 1, and one end of each adjusting post 13 passes through the case 1 to be exposed inside the rotating groove 14. The damping triggers 81 are movably arranged within the rotating groove 14. Specifically, the rotating groove 14 is an annular rotating groove 14, and multiple damping triggers 81 are annularly distributed to be movably arranged within the rotating groove 14. Specifically, the other end of each adjusting post 13 is used for connecting to a spring or the like.

When the damping actuating member 8 is rotated, the damping triggers 81 on the damping actuating member 8 press against the corresponding adjusting posts 13, causing the locking protrusions 131 of the adjusting posts 13 to move to the sides of the corresponding damping plate assemblies 9 to clamp the gears of the damping plate assemblies 9, thereby clamping the damping plate assemblies 9. This prevents the damping plate assemblies 9 from rotating with the pivot shaft 2, thereby generating damping with other damping plate assemblies 9 and thus adjusting the damping of the tripod head.

Moreover, based on the cooperation of the multiple damping triggers 81 and the multiple adjusting posts 13, the damping actuating member 8 can be rotated to control the clamping of different numbers of damping plate assemblies 9, thereby adjusting the damping magnitude and forming different damping gears.

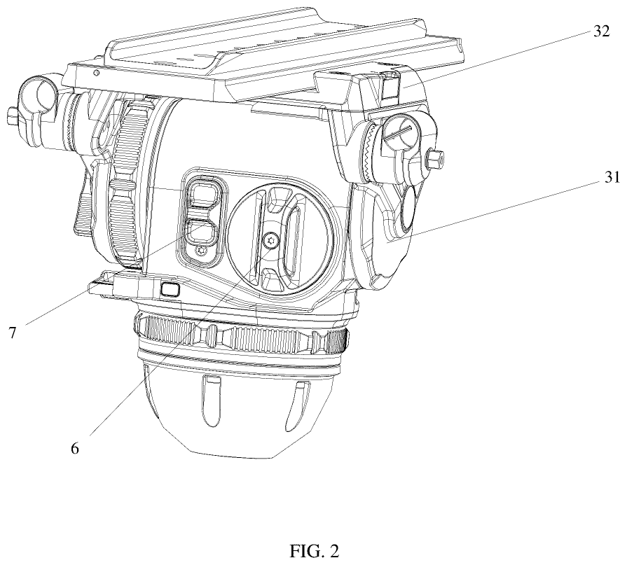

With reference to FIG. 2, in this embodiment, the mounting assembly 3 includes two side plates 31 and a quick-release plate 32 for installing photography equipment. The two side plates 31 are located on the left and right sides of the case 1, respectively, and are fixed to both ends of the pivot shaft 2. The quick-release plate 32 is fixedly arranged between the two side plates 31.

With reference to FIG. 1, in this embodiment, the tripod head further includes a tripod 15, and the case 1 is arranged on the tripod 15.

As used in the claims, the indefinite articles “a” and “an” should be understood to mean “one or more” unless explicitly stated otherwise or unless the context clearly dictates a singular interpretation. The use of these articles does not limit the claimed invention to a single instance of the referenced element but rather encompasses multiple instances where applicable.

As used herein, the terms “member” and “part” each refer to a tangible, physical structure, such as a component, element, or part, which may be formed from any suitable material. Unless explicitly stated otherwise, the use of the term “member” or “part” is not intended to invoke 35 U.S.C. § 112(f), and should not be construed as a means-plus-function limitation.

What is claimed is:

1. A tripod head, comprising:
a case, wherein the case is movably provided with a first actuating member and a second actuating member;
a mounting assembly configured to install a photographic equipment, wherein the mounting assembly is movably provided on the case;
a pivot shaft movably provided inside the case and connected to the mounting assembly;
a plurality of energy storage components sleeved onto the pivot shaft; and
a plurality of locking assemblies configured to control the plurality of energy storage components, wherein the plurality of locking assemblies correspond respectively to the plurality of energy storage components,
wherein the first actuating member is connected to at least one of the plurality of locking assemblies, and the second actuating member is connected to another at least one of the plurality of locking assemblies.

2. The tripod head according to claim 1, further comprising a locking shaft inside the case;
wherein the plurality of locking assemblies comprises a plurality of locking members and a plurality of locking springs;
wherein the plurality of locking members is movably sleeved onto the locking shaft;
wherein a locking groove is provided on one side of each of the plurality of energy storage components;
wherein a first end of each of the plurality of locking members corresponds to the locking groove, and the plurality of locking springs are fixedly provided inside the case and connected to or abutted against a second side of the plurality of locking members; and
wherein the first actuating member is configured to control a second end of a corresponding locking member to compress or release the locking spring, and the second actuating member is configured to control a second end of a corresponding locking member to compress or release the locking spring.

3. The tripod head according to claim 2, wherein a first actuating zone is provided on the case;
wherein the first actuating zone comprises one or more first trigger holes;
wherein a first trigger pin is movably provided inside each of the one or more first trigger holes;
wherein one or more first locking trigger parts are configured to compress the first trigger pin are provided on the first actuating member;
wherein the first actuating member is movably provided on the first actuating zone;
wherein the one or more first locking trigger parts correspond respectively to one or more first trigger pins; and
wherein the first trigger pin is connected to or abutted against one side of the corresponding locking member opposite to the locking spring.

4. The tripod head according to claim 3, wherein the first actuating member is rotatably movably provided in the first actuating zone, and a plurality of actuating beads are circumferentially provided between the first actuating member and the first actuating zone.

5. The tripod head according to claim 3, wherein a plurality of first locking trigger parts are circumferentially arranged in sequence along a diameter of the first actuating member on the first actuating member.

6. The tripod head according to claim 3, wherein a counterweight of an energy storage component corresponding to at least one first trigger pin in the first actuating zone is half of a weight of the energy storage component corresponding to other first trigger pins.

7. The tripod head according to claim 2, wherein a second actuating zone is provided on the case;
wherein the second actuating zone comprises a second trigger hole;
wherein a second trigger pin is movably provided inside the second trigger hole;
wherein a second locking trigger part configured for compressing the second trigger pin is provided on the second actuating member;
wherein the second actuating member is movably provided in the second actuating zone;
wherein the second locking trigger part corresponds to the second trigger pin; and
wherein the second trigger pin is connected to or abutted against one side of the corresponding locking member opposite to the locking spring.

8. The tripod head according to claim 7, wherein a sliding groove is provided in the second actuating zone;
wherein the second trigger hole is provided in the sliding groove; and
wherein the second locking trigger part is vertically movably provided in the sliding groove.

9. The tripod head according to claim 8, wherein a guiding element is arranged on the second actuating zone;
wherein a guide hole is provided on the guiding element;
wherein the guide hole is connected to the sliding groove;
wherein a connecting part is fixed on the second actuating member;
wherein the second actuating member is movably provided on the guiding element; and
wherein the connecting part passes through the guide hole to be connected to the second locking trigger part located in the sliding groove.

10. The tripod head according to claim 1, the plurality of locking assemblies are configured in three parts, wherein one of the three parts is configured to fixedly lock the energy storage components, and the first actuating member is connected to one of the three parts, the second actuating member is connected to another one of the three parts.

11. The tripod head according to claim 1, further comprising a damping actuating member;
wherein the damping actuating member is rotatably arranged on the case;
wherein a plurality of damping plate assemblies are sleeved onto the pivot shaft;
wherein an adjusting post is movably provided on the case;
wherein a locking protrusion configured for clamping the plurality of damping plate assemblies is provided on the adjusting post;
wherein the locking protrusion corresponds to all of the plurality of damping plate assemblies; and
wherein a damping trigger is connected to the adjusting post to drive the locking protrusion to move.
